(19) United States
(12) Patent Application Publication
(10) Pub. No.: US 2006/0195852 A1
(43) Pub. Date: Aug. 31, 2006

(54) Recording and reproducing device with door

(75) Inventors: Daisuke Shimizu, Echizen-city (JP); Hidenobu Mukougawa, Echizen-city (JP); Takayuki Horie, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/362,226

(22) Filed: Feb. 27, 2006

(30) Foreign Application Priority Data
Feb. 28, 2005 (JP) 2005-054271

(51) Int. Cl. G11B 33/02

(52) U.S. Cl. 720/647

(57) ABSTRACT

The invention provides a recording and reproducing device with a door in which the noise generated during carrying in/out of a tray is suppressed as much as possible. The recording and reproducing device has a tray that is carried in and out through an opening formed to a housing, and the door which is biased in the direction shutting the opening via a coil spring. A front edge of the tray is formed contact with a curved surface on a rear face of a door. The front edge of the tray pushes open the door with maintaining the contact with the curved surface when the tray is carried out of the housing through the opening, so that contact noise can be suppressed.

The present application is based on and claims priority of Japanese patent application No. 2005-54271 filed on Feb. 28, 2005, the entire contents of which are hereby incorporated by reference.

### BACKGROUND OF THE INVENTION

1. Field of the Invention

The present invention relates to a recording and reproducing device for recording and reproducing data on a recording medium such as an optical disk, and more specifically, relates to a recording and reproducing device with a door capable of suppressing noise generated by the door being opened and closed when medium is carried into and out of the recording and reproducing device.

2. Description of the Related Art

Heretofore, devices for housing recording media such as optical disks so as to record and reproduce data on the media have been utilized. These devices have trays carried in and out of the device through openings formed for example on the front face thereof, and the openings have doors for preventing dusts and the like from entering the device when the tray is housed in the device. Japanese Patent Application Laid-Open Publication No. 2002-334566 (patent document 1) discloses a disk player having a door provided at an opening through which the tray is carried out and in, wherein the vibration noise of the door can be suppressed by a cushion member attached thereto. Further, Japanese Utility Model Application Laid-Open Publication No. 4-54091 (patent document 2) discloses a optical or magneto optical disk recording and reproducing device having a lid for opening and closing the input/output port through which the disk is inserted and discharged so as to reduce the noise generated during discharge of the disk or the like.

It is possible to suppress the vibration noise generated by the vibration of the speaker by attaching the cushion member according to patent document 1, but the art requires additional work to attach the cushion member and an additional number of components by adding the cushion member, by which the related costs are increased. Moreover, according to the art disclosed in patent document 2, a contact noise is generated by the components being in contact with each other during discharge of the disk or the like.

### SUMMARY OF THE INVENTION

The present invention is aimed at solving the above-mentioned problems. The object of the present invention is to provide a recording and reproducing device with a door capable of suppressing the noise generated during carrying in and out of the tray as much as possible.

According to the present invention, a recording and reproducing device with a door comprises a tray carried in and out through an opening formed to a housing of the recording and reproducing device, a door supported pivotally for shutting the opening, and a biasing means for biasing the pivotally supported door to the direction to shut the opening, wherein a front edge of the tray comes into contact with and pushes open the door, and a curved surface is provided on a rear face portion of the door to which the front edge of the tray pushing open the door contacts, so that when the tray is carried in and out, the front edge of the tray is in contact with and moved along the curved surface.

According to the arrangement of the present invention, the front edge of the tray maintains contact with the curved surface of the door while pushing open the door when the tray is carried out from the interior of the housing through the opening to the exterior resisting against the biasing force of the biasing means, so that the contact noise generated while the front edge of the tray coming into contact with the curved surface is moved from the upper portion of the tray to the bottom side of the tray along the curved surface can be suppressed. Further, since the front edge of the moving tray maintains contact with the curved surface of the door while the tray is carried from the exterior of the housing through the opening into the interior thereof until immediately before the door shuts the opening, the contact noise of the door and the stopper can be suppressed. In other words, when the front edge of the tray contacts the curved surface, the moving tray maintains contact with the curved surface, so that the contact noise generated during opening and closing operation of the door can be suppressed, and as a result, the quality of the recording and reproducing device can be improved.

According to the present invention relates to the recording and reproducing device with a door, further comprising a stopper provided on the housing for stopping the biased door at a position shutting the opening.

According to the present invention, the door being biased toward the direction shutting the opening is stopped by a stopper at a position shutting the opening without entering the housing, so that dust can be prevented from entering through the opening by the door and the contact noise generated during opening and closing operation of the door is suppressed.

According to the present invention relates to the recording and reproducing device with a door, wherein the door is provided with a projected rotary shaft which is pivotally supported by a recessed portion provided on the housing.

According to the present invention, it is possible to replace the prior art door with the present door having a curved surface at the rear face thereof, to suppress the contact noise generated during opening and closing operation of the door. According to the present invention, the costs of the recording and reproducing device can be suppressed since there is no need to additionally provide components such as cushion members that are relatively expensive to suppress contact noise as in the prior art.

According to the present invention relates to the recording and reproducing device with a door, wherein the biasing means is a coil spring.

According to the arrangement of the present invention, the device can be manufactured at low cost since an inexpensive coil spring being formed by spirally coiling a metal wire is used, and the coil can be attached easily by hooking on the ends of the metal wire to position to thereby bias the door toward the direction shutting the opening.

### BRIEF DESCRIPTION OF THE DRAWINGS

FIG. 1 is a perspective view showing a recording and reproducing device according to one embodiment of the present invention;

FIG. 2 is a perspective view of a door provided on the front portion of the recording and reproducing device of FIG. 1;

FIG. 3 is a cross-sectional side view of the recording and reproducing device of FIG. 1 showing the state in which the door is closed;

FIG. 4 is a cross-sectional side view of the recording and reproducing device of FIG. 1 showing the state in which the front edge of a tray is in contact with and slightly pushing open the door;

FIG. 5 is a cross-sectional side view of the recording and reproducing device of FIG. 1 showing the state in which the front edge of the tray is in contact with and pushing open the door; and

FIG. 6 is a cross-sectional side view of the recording and reproducing device showing the state in which the tray is carried out with the door coming into contact with the bottom surface of the tray.

### DETAILED DESCRIPTION OF THE PREFERRED EMBODIMENTS

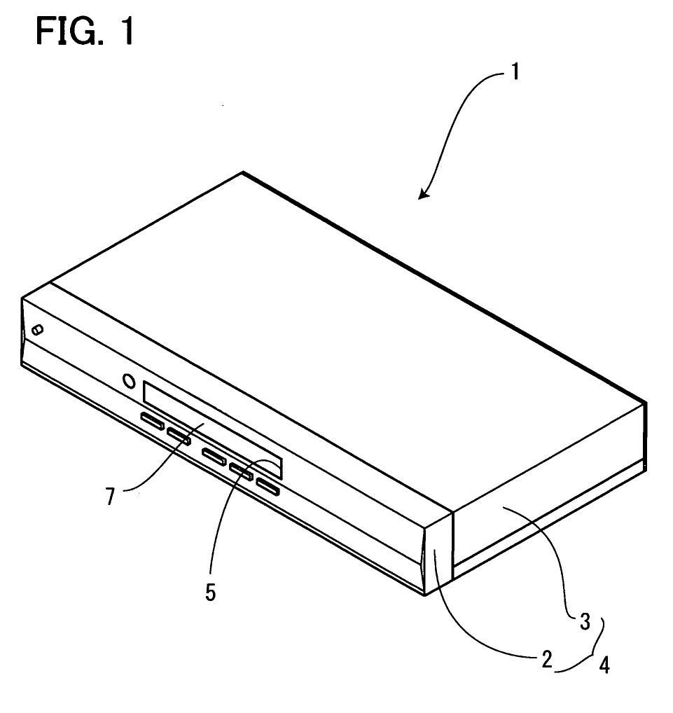

Now, the preferred embodiments for carrying out the present invention will be described with reference to FIGS. 1 through 6. Obviously, the present invention can be applied to arrangements other than that described in the present embodiment within the scope of the invention.

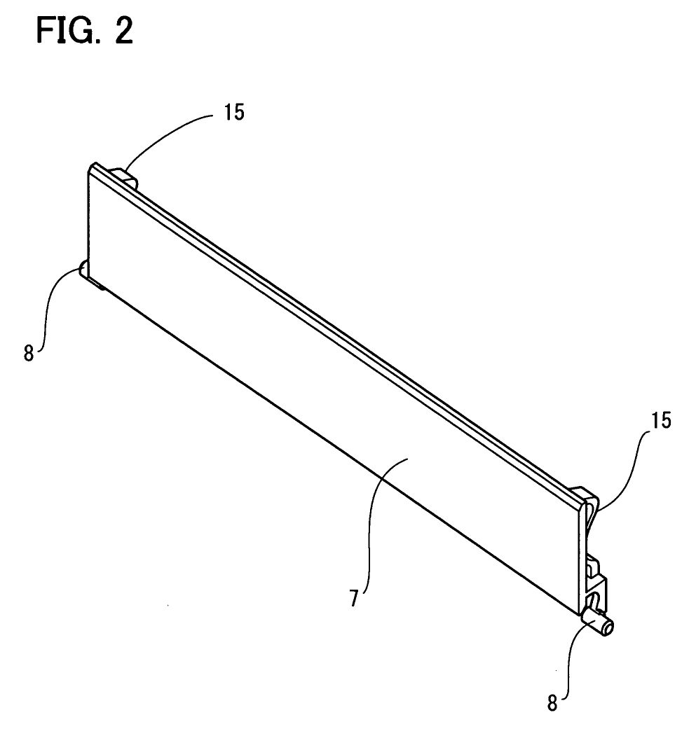

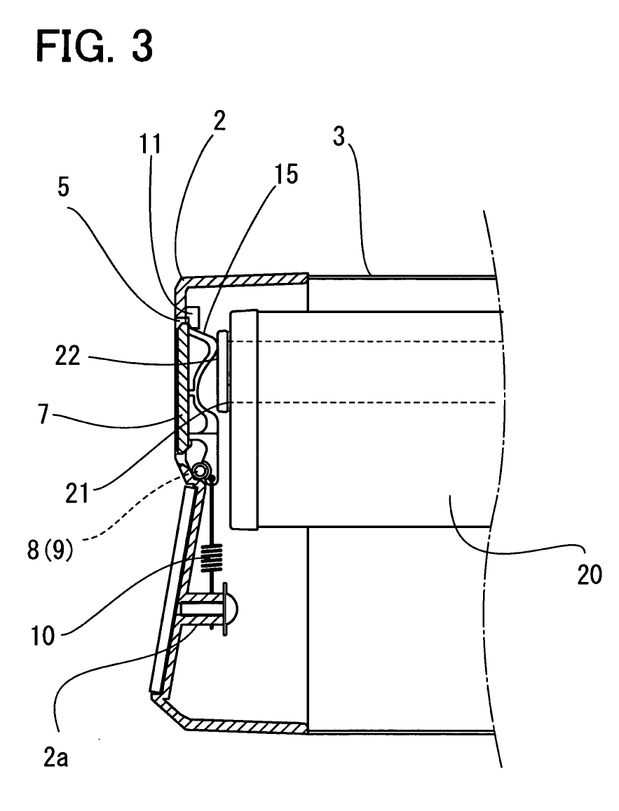

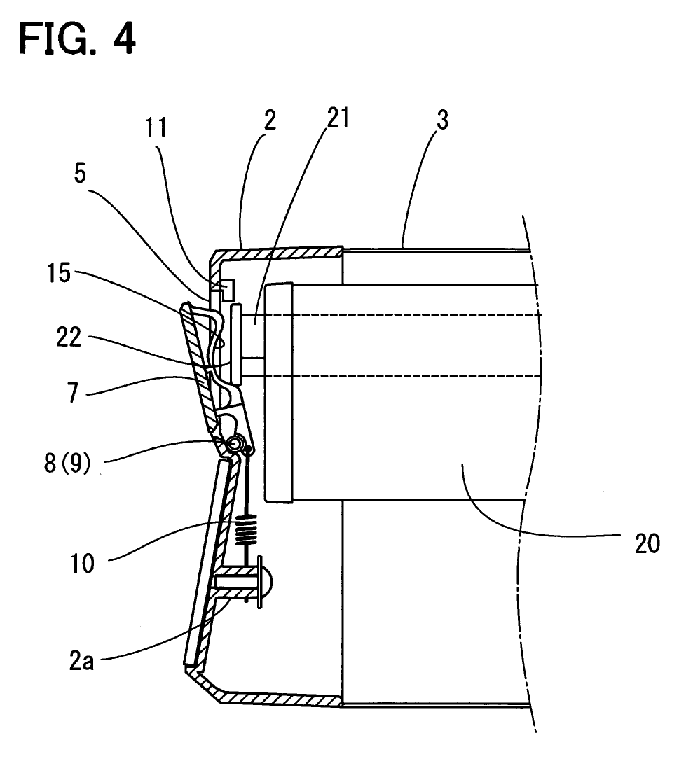

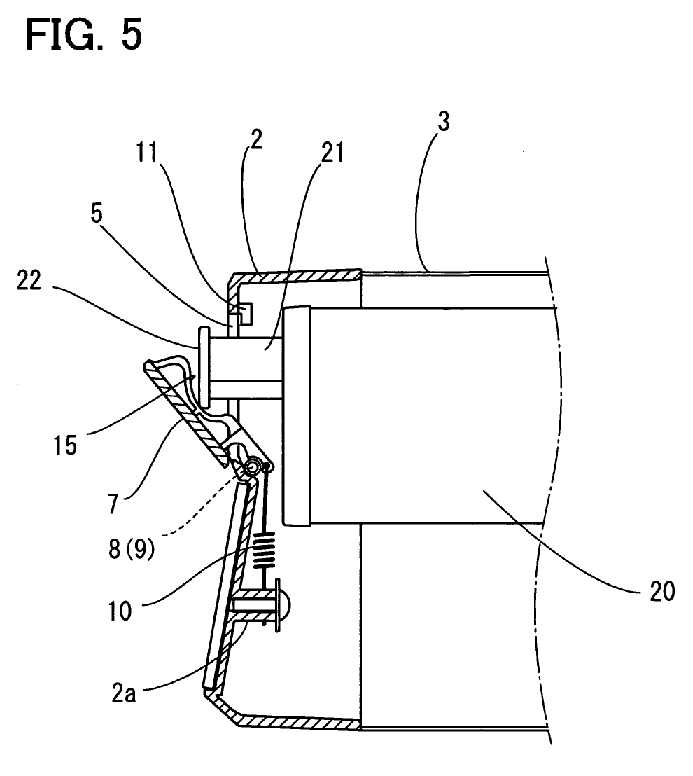

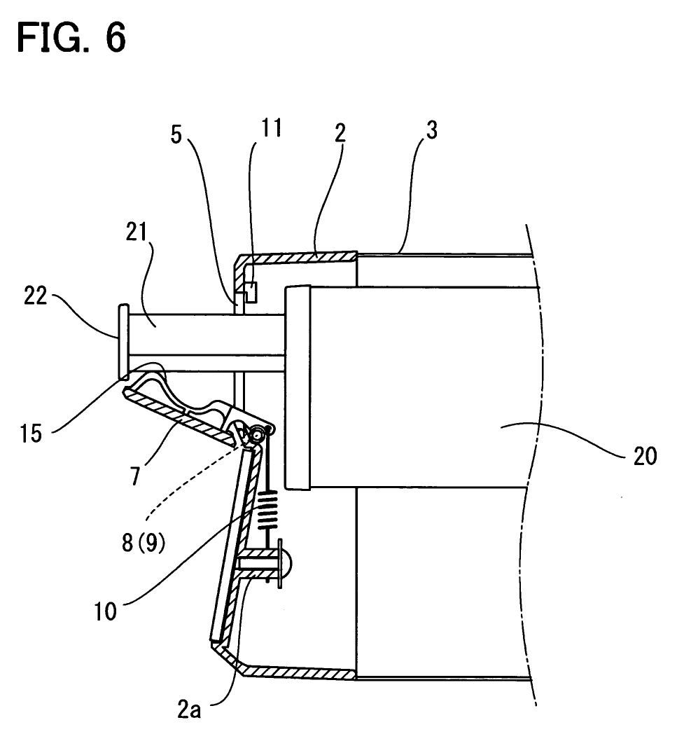

FIG. 1 is a perspective view showing a recording and reproducing device with a door according to one example of the present invention, FIG. 2 is a perspective view showing a door provided on a front portion of the recording and reproducing device with a door, FIG. 3 is a cross-sectional side view of the recording and reproducing device with a door showing the state in which the door is closed, FIG. 4 is a cross-sectional side view of the recording and reproducing device with a door showing the state in which a front edge of a tray is in contact with and slightly pushing open the door, FIG. 5 is a cross-sectional side view of a recording and reproducing device with a door showing the state in which the front edge of the tray is in contact with and pushing open the door, and FIG. 6 is a cross-sectional side view of a recording and reproducing device with a door showing the state in which a tray is discharged with the door being in contact with the bottom surface of the tray.

As illustrated in FIGS. 1 through 6, a recording and reproducing device with a door (hereinafter simply referred to as recording and reproducing device) 1 is for recording and/or reproducing data on optical disks such as DVDs, having a substantially box shaped structure with a housing 4 composed of a front panel 2 and a rear cabinet 3. Further, an opening 5 is formed on a front face of the front panel 2, and a door 7 is supported via projected rotary shafts 8 formed to protrude from both ends of the door 7 on recessed portions 9 formed to the front panel 2, by which the door 7 is pivotally supported on the front panel 2 so as to shut the opening 5. Further, a wave-like curved surface 15 is provided on a rear surface of the door 7.

On the bottom portion of the door 7 is fixed one end of a spiral-shaped metallic coil spring 10 functioning as a bias means, the coil spring having its opposite end from the first end fixed to a projected portion 2a of the front panel 2, so that the upper portion of the door 2 is pressed onto a stopper 11 provided integrally to the front panel 2. In other words, the coil spring 10 biases the door 7 toward the direction shutting the opening 5.

Reference number 20 shows a recording and reproducing unit for housing the optical disk, wherein the recording and reproducing unit 20 includes a tray 21 for mounting the optical disk and carrying the same in and out through the opening 5 formed to the front panel 2 via a drive mechanism not illustrated, and as shown in FIG. 3, the tray 21 moves slightly forward from the state in which the front edge 22 of the tray is in contact with the curved surface 15, to push open the door 7 by the tray 21 being carried out resisting against the biasing force of the spring, as shown sequentially in FIGS. 4 through 6. Further, during the state in which the tray 21 is being carried out or carried in, the front edge 22 of the tray 21 maintains contact with the curved surface 15 while the tray is moved, so that when the tray 21 is carried out from inside the housing 4 through the opening 5 to the exterior, it is possible to suppress the contact noise from the time the front edge 22 contacts the curved surface 15 formed to the rear face of the door 7 to the time the door is moved to the bottom surface of the tray 21 along the curved surface 15. Further, when the tray 21 is carried in from the exterior of the housing 4 through the opening 5 to the interior, the front edge 22 of the tray 21 moves while maintaining contact with the curved surface 15 of the door 7 until the door 7 is as close to the stopper 11 as possible, so the contact noise generated by the door 7 colliding against the stopper 11 can be suppressed. Accordingly, the contact noise generated during opening and closing operation of the door 7 can be suppressed, which leads to improved quality of the recording and reproducing device 1.

Further, the contact noise can be suppressed easily by replacing the door having a flat rear face used in the prior art device with the door 7 having a curved surface 15 on the rear face thereof or changing the design of the prior art door to have a curved rear surface, so there is no need to addrelatively expensive components such as cushion members to suppress the contact noise. Therefore, the costs of the recording and reproducing device can be suppressed.

As described, according to one example of the present invention, the rear face of the door 7 to which contacts the front edge 22 of the tray 21 that pushes open the door 7 is provided with a curved surface 15, so that the front edge 22 of the tray 21 contacts and moves along the curved surface 15 while the tray is being carried in and out. Therefore, when the tray 21 is carried out from the interior of the housing 4 through the opening 5 to the exterior resisting against the biasing force of the biasing means, the front edge 22 of the tray 21 pushes open the door 7 while maintaining contact with the curved surface 15 of the door 7, so that the contact noise can be suppressed while the front edge 22 of the tray 21 in contact with the curved surface 15 moves from the upper side to the bottom side of the tray 21. Moreover, when the tray 21 is carried from the exterior of the housing 4 through the opening 5 into the interior thereof, the front edge 22 of the moving tray 21 maintains contact with the curved surface 15 of the door 7 until immediately before the door 7 shuts the opening 5, the contact noise generated between the door 7 and the stopper 11 can be suppressed. In other words, once the front edge 22 of the tray 21 comes into contact with the wave-like curved surface 15, the moving tray maintains the contact state, according to which the contact noise generated during the opening and closing operation of the door 7 can be suppressed, and the quality of the recording and reproducing device is improved. Further, since the shape of the curved surface 15 of the door 7 in contact with the front edge 22 of the tray 21 has a wave-like design, the time during which the door 7 and the tray 21 maintain contact during the carrying in/out of the tray 21 is elongated, and since the contact status is maintained, the contact noise generated by the tray 21 coming into contact with the door 7 can be suppressed as much as possible.

Further, since a stopper 11 is provided on a housing 4 for stopping the biased door 7 in a position shutting the opening 5, the stopper 11 prevents the door 7 biased toward the direction shutting the opening 5 from entering the housing 4 and infallibly stops the door at the desired position shutting the opening 5, preventing dust from entering through the opening 5.

Moreover, since the projected rotary shafts 8 provided on the door 7 are removably received in the recessed portions 9 formed to the housing 4, the conventional door having a flat rear surface can easily replaced with the present door 7 having the curved surface 15 on the rear face of thereof. Therefore, there is no need to additionally provide relatively expensive components such as cushion members for suppressing the contact noise separately as in the prior art, and the costs of the recording and reproducing device 1 can be cut down.

Even further, since a coil spring 10 in which a metal wire is coiled spirally is utilized as the biasing means, the costs of the present device can be further reduced by utilizing the inexpensive coil spring 10 which is mass-produced as a general purpose component. Moreover, since the coil spring 10 is a metal wire, it can be attached easily by having its ends hooked onto position or the like, to easily bias the door toward the direction shutting the opening 5.

One preferred embodiment of the present invention has been described in detail above. However, the invention is not limited to the preferred embodiment described above, and various modifications are possible within the scope of the present invention, such as forming shaft portions to the housing4 instead of the recessed portions 9 corresponding to the rotary shaft and forming recessed portions instead of the rotary shafts 8 on the door 7, so as to pivotally support the door 7 on the housing 4.

The effects of the present invention are as follows.

According to the present invention, the recording and reproducing device with a door comprises a tray carried in and out through an opening formed to a housing of the recording and reproducing device, a door supported pivotally for shutting the opening, and a biasing means for biasing the pivotally supported door toward the direction shutting the opening, wherein a front edge of the tray comes into contact with and pushes open the door, and a curved surface is provided on a rear face portion of the door to which the front edge of the tray pushing open the door contacts, so that when the tray is carried in and out, the front edge of the tray is in contact with and moved along the curved surface. Thus, the present invention provides a recording and reproducing device capable of suppressing contact noise during opening and closing operation of the door and having improved quality.

According to the present invention, the recording and reproducing device with a door further comprises a stopper provided on the housing for stopping the biased door at a position shutting the opening. Therefore, the present invention can prevent dust from entering the device in addition to suppressing the noise generated during opening and closing operation of the door.

According to present invention, the recording and reproducing device with a door characterizes in that the door is provided with a projected rotary shaft which is pivotally supported by a recessed portion provided on the housing, so that the conventional door can easily be replaced with the present door with a curved rear surface. Therefore, there is no need according to the present invention to additionally provide relatively expensive components such as cushion members to suppress contact noise as in the prior art device, and a recording and reproducing device having reduced costs can be provided.

According to the present invention, the recording and reproducing device with a door characterizes in that the biasing means is a coil spring. Since the coil spring is a metal wire coiled spirally and is inexpensive, the present invention provides a recording and reproducing device that can be manufactured cost-effectively.

What is claimed is:

1. A recording and reproducing device with a door comprising:
a tray carried in and out through an opening formed to a housing of the recording and reproducing device;
a door supported pivotally for shutting the opening; and
a biasing means for biasing the pivotally supported door toward the direction shutting the opening;
wherein a front edge of the tray comes into contact with and pushes open the door; and
a curved surface is provided on a rear face portion of the door to which the front edge of the tray pushing open the door contacts, so that when the tray is carried in and out, the front edge of the tray is in contact with and moved along the curved surface.

2. The recording and reproducing device with a door according to claim 1, further comprising a stopper provided on the housing for stopping the biased door at a position shutting the opening.

3. The recording and reproducing device with a door according to claim l, wherein the door is provided with a projected rotary shaft which is pivotally supported by a recessed portion formed on the housing.

4. The recording and reproducing device with a door according to claim 2, where in the door is provided with a projected rotary shaft which is pivotally supported by a recessed portion formed on the housing.

5. The recording and reproducing device with a door according to claim 1, wherein the biasing means is a coil spring.

6. The recording and reproducing device with a door according to claim 2, wherein the biasing means is a coil spring.

7. The recording and reproducing device with a door according to claim 3, wherein the biasing means is a coil spring.

8. The recording and reproducing device with a door according to claim 4, wherein the biasing means is a coil spring.
